(19) United States
(12) Patent Application Publication
(10) Pub. No.: US 2024/0286095 A1
(43) Pub. Date: Aug. 29, 2024

(54) SYSTEMS AND RELATED METHODS FOR DISPERSING PARTICLES IN A FLUID OF A FLUID CONTAINER

(71) Applicant: BATTELLE SAVANNAH RIVER ALLIANCE, LLC, AIKEN, SC (US)

(72) Inventors: CHRISTOPHER A. SOBECKI, AIKEN, SC (US); KAI HAN, EVANS, GA (US)

(21) Appl. No.: 18/174,002

(22) Filed: Feb. 24, 2023

(51) Int. Cl. B01F 33/451; B01F 23/50

(52) U.S. Cl. CPC B01F 33/451; B01F 23/56; B01F 23/59

(57) ABSTRACT

In one aspect, a system for dispersing particles in a fluid of a fluid container includes one or more permanent magnets, one or more electric coils, and/or one or more electrodes. The one or more permanent magnets, one or more electric coils, and/or one or more electrodes are configured to disperse the particles in the fluid of the fluid container.

### FEDERAL RESEARCH STATEMENT

This invention was made with government support under Contract No. 89303321CEM000080 awarded by the U.S. Department of Energy. The government has certain rights in the invention.

### FIELD

This present subject matter relates generally to dispersing particles and, more particularly, to systems and related methods for dispersing particles in a fluid of a fluid container.

### BACKGROUND

Generally, fluids containing particles are utilized in a number of various applications. For instance, a fluid containing selectively chosen particles may be utilized in processes involving heat transfer, mass transfer, flow controls to extend battery life, lubricants, and even the production of medicine for drug delivery.

However, the reusability and stability of fluids containing particles may be limited by the settling of the particles in a respective fluid. Indeed, forces such as gravity, electrostatic repulsion, and Van der Waals will generally result in the settling of the particles in a fluid at the bottom of the fluid container containing the fluid. Notably, the settling of the particles in the fluid may limit the efficacy of the fluid in various processes. In the past, mechanical stirrers (e.g., magnetic stirrers) and chemical surfactants have been utilized to mitigate the settling of particles in a fluid and/or disperse settled particles in a fluid. However, these methods require the addition of a stirrer and a chemical respectively to the fluid containing the particles. In this respect, these methods may be considered invasive, may affect the physical or chemical characteristics of the fluid, and may expose workers to harmful chemicals. Further, these methods may require constant particle aggregation and expensive equipment and/or chemicals. Thus, there is a need for an improved system and related method for dispersing particles in a fluid of a fluid container.

### SUMMARY OF THE INVENTION

Aspects and advantages of the invention will be set forth in part in the following description, or may be obvious from the description, or may be learned through practice of the invention.

In one aspect, the present subject matter is directed to a system for dispersing particles in a fluid of a fluid container. The system may include: a fluid container comprising a fluid and a plurality of particles; and a controller element, the controller element configured to control one or more electric coils or one or more permanent magnets, the one or more electric coils or the one or more permanent magnets configured to sequentially generate a first electromagnetic field relative to the fluid container to aggregate the plurality of particles into one or more particle clusters, a second electromagnetic field relative to the fluid container to raise the one or more particle clusters relative to a top wall of the fluid container, and a third electromagnetic field relative to the fluid container that breaks apart the one or more raised particle clusters.

In one aspect, the present subject matter is directed to a system for dispersing particles in a fluid of a fluid container. The system may include: a fluid container containing a fluid and a plurality of particles; two or more pairs of electrodes positioned relative to the fluid container, each of the two or more pairs of electrodes being configured to generate an electric field upon activation of the respective pair of electrodes; and a controller configured to sequentially activate the two or more pairs of electrodes such that the plurality of particles are dispersed across at least a portion of the fluid container.

In one aspect, the present subject matter is directed to a system for dispersing particles in a fluid of a fluid container. The system may include: a fluid container containing a fluid and a plurality of particles; a plurality of permanent magnets positioned relative to the fluid container; at least one magnet driving element coupled to the plurality of permanent magnets and being configured to rotate the plurality of permanent magnets relative to the fluid container; and a controller element configured to control at least one magnet driving element such that the at least one magnet driving element rotates the plurality of permanent magnets relative to the fluid container in a manner that causes eddy currents to be formed relative to the fluid container, the eddy currents resulting in turbulence being created within the fluid to facilitate dispersion of the plurality of particles across at least a portion of the fluid container.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 illustrates a schematic view of one embodiment of a system for dispersing particles in a fluid of a fluid container in accordance with aspects of the present subject matter;

FIG. 2 illustrates a plan view of one embodiment of a magnet support member in accordance with aspects of the present subject matter;

FIG. 3 illustrates a plan view of another embodiment of a magnet support member in accordance with aspects of the present subject matter;

FIG. 4 illustrates a rotational axis of a magnet support member in accordance with aspects of the present subject matter;

FIG. 5 illustrates a schematic view of another embodiment of a system for dispersing particles in a fluid of a fluid container in accordance with aspects of the present subject matter;

FIG. 6 illustrates a schematic view of a further embodiment of a system for dispersing particles in a fluid of a fluid container in accordance with aspects of the present subject matter;

FIG. 7 illustrates a schematic view of yet another embodiment of a system for dispersing particles in a fluid of a fluid container in accordance with aspects of the present subject matter;

FIG. 8 illustrates a schematic view of another embodiment of a system for dispersing particles in a fluid of a fluid container in accordance with aspects of the present subject matter;

FIG. 9 illustrates a schematic view of a further embodiment of a system for dispersing particles in a fluid of a fluid container in accordance with aspects of the present subject matter;

FIG. 10 illustrates a schematic view of yet another embodiment of a system for dispersing particles in a fluid of a fluid container in accordance with aspects of the present subject matter;

FIG. 11 illustrates a plan view of one embodiment of a fluid container in accordance with aspects of the present subject matter;

FIG. 12 illustrates a flow diagram of one embodiment of a method for dispersing particles in a fluid of a fluid container in accordance with aspects of the present subject matter;

FIG. 13 illustrates a flow diagram of another embodiment of a method for dispersing particles in a fluid of a fluid container in accordance with aspects of the present subject matter;

FIG. 14 illustrates a flow diagram of a further embodiment of a method for dispersing particles in a fluid of a fluid container in accordance with aspects of the present subject matter; and

FIG. 15 illustrates a flow diagram of yet another embodiment of a method for dispersing particles in a fluid of a fluid container in accordance with aspects of the present subject matter.

Repeat use of reference characters in the present specification and drawings is intended to represent the same or analogous features or elements of the present invention.

### DETAILED DESCRIPTION

Reference will now be made in detail to various embodiments of the disclosed subject matter, one or more examples of which are set forth below. Each embodiment is provided by way of explanation of the subject matter, not limitation thereof. In fact, it will be apparent to those skilled in the art that various modifications and variations may be made in the present disclosure without departing from the scope or spirit of the subject matter. For instance, features illustrated or described as part of one embodiment, may be used in another embodiment to yield a still further embodiment.

In general, the present disclosure is directed to systems and related methods for dispersing particles in a fluid contained in a fluid container. The systems and methods disclosed herein for dispersing particles in a fluid contained in a fluid container may include one or more permanent magnets, one or more electromagnetic coils, and/or one or more electrodes. A system or method disclosed herein for dispersing particles may have enhanced efficiency compared to traditional particle dispersion systems and methods. For instance, the particle dispersion system of the present disclosure may be able to enhance the stability or homogeneity of a particle-loaded fluid as compared to traditional particle dispersion systems. Notably, in some aspects, the systems and methods disclosed herein may not involve subjecting the fluid or the particles of a particle-loaded fluid to an external mixing device (e.g., magnetic stirrer) or a chemical surfactant.

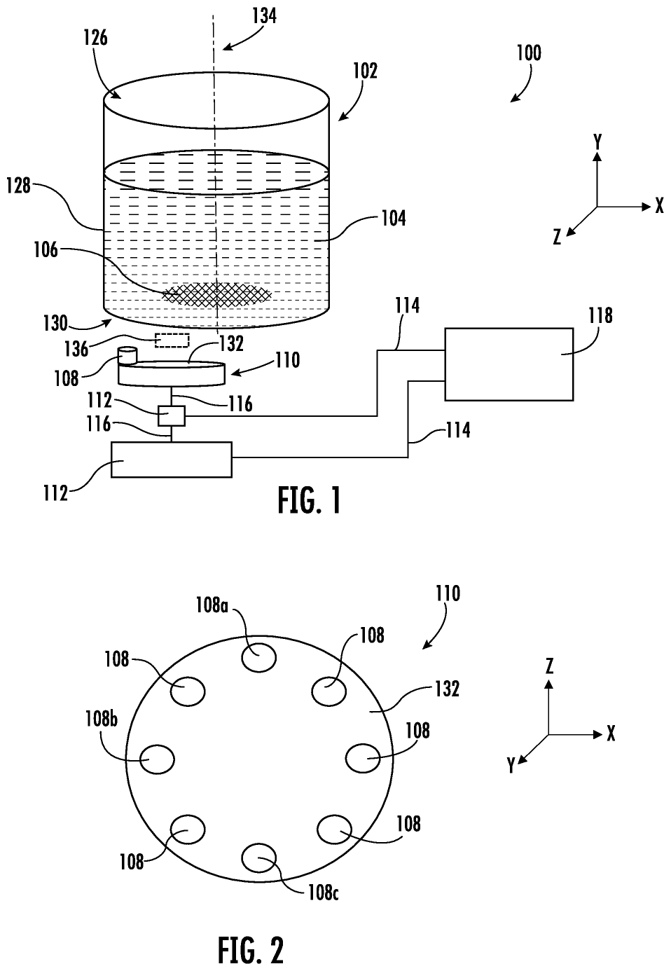

Referring now to the drawings, FIG. 1 illustrates one embodiment of a system 100 for dispersing a plurality of particles 106 in a fluid 104 contained in a fluid container 102 in accordance with aspects of the present subject matter. As illustrated in FIG. 1, the system 100 may include a fluid 104. Generally, the fluid 104 may be any fluid 104 (e.g., water, oil) known in the art that may contain a plurality of particles 106. As further illustrated in FIG. 1, the system 100 may include a plurality of particles 106. In one aspect, at least a portion of the particles of the plurality of particles 106 may be magnetic particles. Notably, in one aspect, the magnetic particles of the plurality of particles 106 may include diamagnetic particles, paramagnetic particles, superparamagnetic particles, ferromagnetic particles, antiferromagnetic particles, or a combination thereof.

In general, the particles of the plurality of particles 106 may have a selectively chosen shape. For instance, the particles of the plurality of particles 106 may have a spherical shape (e.g., ellipsoid, disc, doublet, etc.) or prismatic shape. In one aspect, the particles of the plurality of particles 106 may have a selectively chosen average particle size. For instance, the particles of the plurality of particles 106 may have an average particle size of 5 mm or less, such as 4.5 mm or less, such as 4 mm or less, such as 3.5 mm or less, such as 3 mm or less, such as 2.5 mm or less, such as 2 mm or less, such as 1.5 mm or less, such as 1000 microns or less, such as 900 microns or less, such as 800 microns or less, such as 700 microns or less, such as 600 microns or less, such as 500 microns or less, such as 400 microns or less, such as 300 microns or less, such as 200 microns or less, such as 150 microns or less, such as 100 microns or less, such as 75 microns or less, such as 50 microns or less, such as 40 microns or less, such as 25 microns or less, such as 15 microns or less, such as 10 microns or less, such as 5 microns or less, such as 1 micron or less, such as 900 nanometers or less, such as 800 nanometers or less, such as 600 nanometers or less, such as 500 nanometers or less, such as 300 nanometers or less, such as 200 nanometers or less, such as 100 nanometers or less, such as 50 nanometers or less, such as 25 nanometers or less, such as 10 nanometers or less. The particles of the plurality of particles 106 may have an average particle size of 5 nanometers or more, such as 10 nanometers or more, such as 20 nanometers or more, such as 30 nanometers or more, such as 40 nanometers or more, such as 50 nanometers or more, such as 100 nanometers or more, such as 250 nanometers or more, such as 500 nanometers or more, such as 750 nanometers or more, such as 1 micron or more, such as 5 microns or more, such as 10 microns or more, such as 20 microns or more, such as 50 microns or more, such as 100 microns or more, such as 200 microns or more, such as 300 microns or more, such as 400 microns or more, such as 500 microns or more, such as 600 microns or more, such as 700 microns or more, such as 800 microns or more, such as 900 microns or more, such as 1000 microns or more, such as 1.5 mm or more, such as 2 mm or more, such as 2.5 mm or more, such as 3 mm or more, such as 3.5 mm or more, such as 4 mm or more, such as 4.5 mm or more. Furthermore, in one aspect, the aforementioned values may refer to a median particle size of the particles of the plurality of particles 106. In this respect, the particles of the plurality of particles 106 may have a D10, D50, or D98 of any of the values previously disclosed, including any incremental values therebetween.

As illustrated in FIG. 1, the system 100 may include a fluid container 102. In one aspect, the material of which the fluid container 102 is formed may include a metal, a plastic, a glass, or a combination thereof. For instance, the fluid container 102 may comprise a metal such as aluminum, carbon steel, chromium, cobalt, copper, dysprosium, gadolinium, iron, lead, magnesium, manganese, neodymium, nickel, platinum, steel, tin, tin-free steel, titanium, zinc, or a combination or alloy thereof. In one aspect, the fluid container 102 may comprise a plastic such as a polycarbonate (PC), a polyethylene (PE), a polyethylene terephthalate (PET), a polypropylene (PP), a polyvinyl chloride (PVC), or a combination thereof. Further, in one aspect, the fluid container 102 may comprise glass, plexiglass, silicone, silicon, polydimethylsiloxane (PDMS), ceramic, Pyrex®, alkali-free glass, soda-lime glass, quartz/fused silica, high impact polystyrene (HIPS), polyvinylidene fluoride (PVDF), ethylene chlorotrifluoroethylene (ECTFE), perfluoro alkoxy alkane (PFA), fluorinated perfluoro ethylene propylene (FEP), Teflon®, or a combination thereof. The fluid container 102 may include a top wall 126, a side wall 128, a bottom wall 130, or a combination thereof. In one aspect, a fluid container 102 may comprise a top wall 126, a bottom wall 130, and a side wall 128 extending between the top wall 126 and the bottom wall 130. In one aspect, the outer perimeter of the fluid container 102 may be defined by at least one side wall 128.

Generally, the fluid container 102 may be of any shape and/or size. For instance, as illustrated in FIG. 1, the fluid container may be in the shape of a cylinder. In one aspect, the fluid container 102 may have a selectively chosen internal volume. For instance, the fluid container 102 may have a volume of 1 liter or more, such as 5 liters or more, such as 10 liters or more, such as 50 liters or more, such as 100 liters, or more, such as 500 liters or more, such as 1000 liters or more, such as 1500 liters or more, such as 2000 liters or more.

As illustrated in FIG. 1, the system 100 may include one or more permanent magnets 108, such as a plurality of permanent magnets. In general, the one or more permanent magnets 108 may comprise barium, cobalt, dysprosium, gadolinium, iron, magnesium, neodymium, nickel, strontium, zinc, or a combination or alloy thereof. Further, for instance, one or more permanent magnets 108 may comprise an alnico, an aluminum iron alloy, a cobalt iron alloy, a copper iron alloy, a copper nickel alloy, erbium, a hematite, holmium, iron carbide, a magnesium iron alloy, manganese dioxide, a nickel iron alloy, a nickel copper iron alloy, or a combination thereof. Additionally, for instance, the one or more permanent magnets 108 may comprise ferromagnetic ceramics (e.g., nickel ferrite, zinc ferrite). In one aspect, the one or more permanent magnets 108 may include a horseshoe magnet, a bar magnet, a disc magnet, a spherical magnet (e.g., sphere magnet), a ring magnet, a donut magnet, a grate magnet, a cylinder magnet, or a combination thereof.

In general, the one or more permanent magnets 108 may be supported relative to the fluid container 102 by a magnet support member 110. In one aspect, the one or more permanent magnets 108 may be affixed to a magnet support member 110. For instance, the magnet support member 110 may have one or more permanent magnets 108 affixed to a surface 132 of the magnet support member 110. The magnet support member 110 may be of any shape and/or size. For instance, as illustrated in FIG. 2, the magnet support member 110 may be circular. In one aspect, the magnet support member 110 may comprise wood, plastic, ceramic, masonry material, glass (e.g., plexiglass, alkali-free glass, soda-lime glass), papier-mâché, fiberglass, rubber, polymer, silicone, or a combination thereof.

Generally, the one or more permanent magnets 108 may be spaced at a selectively chosen position between the center of a surface 132 of the magnet support member 110 and the perimeter of the surface 132 of the magnet support member 110. For instance, the one or more permanent magnets 108 may be positioned at about 0.1% or more of the distance from the center of a surface 132 of the magnet support member 110 to the perimeter of the surface 132 of the magnet support member 110, such as about 1% or more, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less. For instance, in one aspect, a magnet of the one or more permanent magnets 108 that is positioned at 50% of the distance from the center of a surface 132 of the magnet support member 110 to the perimeter of the surface 132 of the magnet support member 110 is equidistant from the center of the surface 132 of the magnet support member 110 and the perimeter of the surface 132 of the magnet support member 110. Further, for instance, a magnet of the one or more permanent magnets 108 that is positioned at 90% of the distance from the center of a surface 132 of the magnet support member 110 to the perimeter of the surface 132 of the magnet support member 110 is positioned at 90% of the total distance from the center of the surface 132 of the magnet support member 110 to the perimeter of the surface 132 of the magnet support member 110 and is positioned at 10% of the total distance from the perimeter of the surface 132 of the magnet support member 110 to the center of the surface 132 of the magnet support member 110. In this respect, for instance, when the distance from the center of a surface 132 of the magnet support member 110 to the perimeter of the surface 132 of the magnet support member 110 is 1 meter, a magnet of the one or more permanent magnets 108 that is positioned at 90% of the distance from the center of the surface 132 of the magnet support member 110 to the perimeter of the surface 132 of the magnet support member 110 is positioned 0.9 meters away from the center of the surface 132 of the magnet support member 110. In one aspect, when the magnet support member 110 is circular, such as the magnet support member 110 illustrated in FIG. 2, the distance from the center of a surface 132 of the magnet support member 110 to the perimeter of the surface 132 of the magnet support member 110 may be referred to as the radius of the magnet support member 110.

In general, the one or more permanent magnets 108 may be positioned at one or more magnet position angles. The magnet position angle at which a magnet of the one or more permanent magnets 108 is positioned is determined from the perspective of an observer viewing a surface 132 of the magnet support member 110 from above, as illustrated in FIG. 2. Such a view may be referred to as a plan view. With respect to the magnet position angle, the magnet position angle is determined on the x-z plane, with “x” and “z” being horizontal directions that are perpendicular to one another, as illustrated in FIG. 2. With respect to the magnet position angle, one arm of the magnet position angle extends in the right, horizontal direction and the other arm of the angle extends in the direction of the center (e.g., center of mass, center of volume) of a respective magnet of the one or more permanent magnets 108. The vertex of these two arms of the magnet position angle is formed in the center of the magnet support member 110.

As previously disclosed, the one or more permanent magnets 108 may be positioned at one or more magnet position angles. For instance, as illustrated in FIG. 2, a magnet 108a of the one or more permanent magnets 108 may be positioned at a 90° magnet position angle. Further, for instance, as illustrated in FIG. 2, a magnet 108b of the one or more permanent magnets 108 may be positioned at a 180° magnet position angle. Furthermore, for instance, as illustrated in FIG. 2, a magnet 108c of the one or more permanent magnets 108 may be positioned at a 270° magnet position angle. It should be understood that the subscripts of the respective magnets 108a, 108b, and 108c, are utilized for illustrative purposes only and are not necessarily indicative of differences between the respective magnets.

In general, a magnet of the one or more permanent magnets 108 may be affixed, positioned, adjacent, or supported on the surface 132 of the magnet support member 110 at a magnet position angle of 0° or more, such as 20° or more, such as 40° or more, such as 80° or more, such as 120° or more, such as 160° or more, such as 200° or more, such as 240° or more, such as 280° or more, such as 320° or more, such as 359° or less, such as 320° or less, such as 280° or less, such as 240° or less, such as 200° or less, such as 160° or less, such as 120° or less, such as 80° or less, such as 40° or less, such as 20° or less, including all increments of 1° therebetween.

In general, the one or more permanent magnets 108 may be positioned at a selectively chosen magnet orientation position. In one aspect, a north pole of one or more magnets of the one or more permanent magnets 108 may be positioned adjacent or affixed to a surface 132 of the magnet support member 110 such that the south pole of the magnet of the one or more permanent magnets 108 is closer to the fluid container 102. In one aspect, a south pole of one or more magnets of the one or more permanent magnets 108 may be positioned adjacent or affixed to a surface 132 of the magnet support member 110 such that the north pole of the magnet of the one or more permanent magnets 108 is closer to the fluid container 102. Notably, the one or more permanent magnets 108 may have one or more magnets having the same magnet orientation position or having a different magnet orientation position. For instance, in one aspect, the one or more permanent magnets 108 may have at least one magnet of the one or more permanent magnets 108 having a south pole adjacent or affixed to a surface 132 of the magnet support member 110 and may have at least one magnet of the one or more permanent magnets 108 having a north pole adjacent or affixed to a surface 132 of the magnet support member 110.

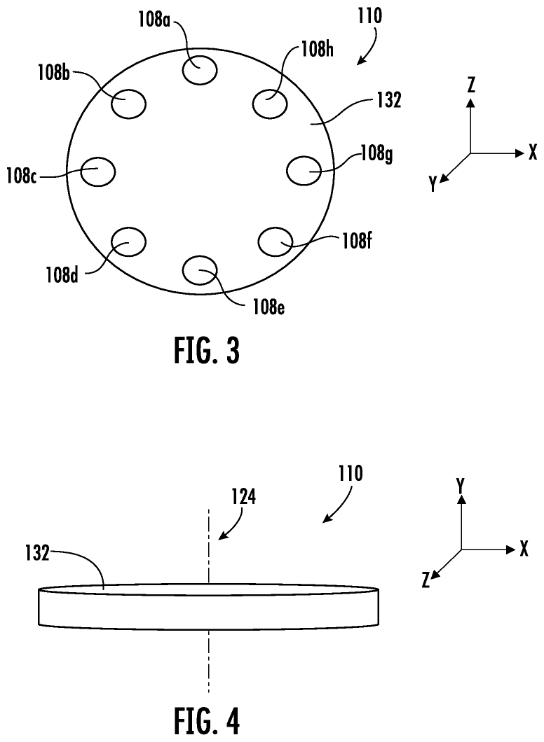

In general, magnets of the one or more permanent magnets 108 that have different magnet orientation positions may be referred to as having different polarities (e.g., a first polarity, a second polarity, a third polarity, etc.). In one aspect, the one or more permanent magnets 108 may have a set of first permanent magnets of a first polarity and a set of second permanent magnets of a second polarity. For instance, the one or more permanent magnets 108 may have a set of first permanent magnets and a set of second permanent magnets, with each magnet of the set of first permanent magnets having a magnet orientation position where the south pole of the magnet is adjacent or affixed to a surface 132 of the magnet support member 110 and with each magnet of the set of second permanent magnets having a magnet orientation position where the north pole of the magnet is adjacent or affixed to a surface 132 of the magnet support member 110. In this respect, in one aspect, the north pole of each magnet of the set of first permanent magnets may be positioned closer to the fluid container 102 and the south pole of each magnet of the set of second permanent magnets may be positioned closer to the fluid container 102. Notably, as illustrated in FIG. 3, a first set of permanent magnets and a second set of permanent magnets may be positioned in an alternating arrangement across a magnet support member 110. In FIG. 3, the first set of permanent magnets includes magnets 108a, 108c, 108e, and 108g and the second set of permanent magnets includes 108b, 108d, 108f, and 108h. With respect to FIG. 3, the first set of permanent magnets may have a first polarity and the second set of permanent magnets may have a second, different polarity such that a first set of permanent magnets and a second set of permanent magnets may be positioned in an alternating arrangement. In another aspect, all of the magnets of the one or more permanent magnets 108 may have the same polarity. It should be understood that the subscripts of the respective magnets 108a, 108b, 108c, 108d, 108e, 108f, 108g, and 108h are utilized for illustrative purposes only and are not necessarily indicative of differences between the respective magnets.

In one aspect, one or more magnets of the one or more permanent magnets 108 may be positioned away from the fluid container 102 at a selectively chosen distance. For instance, one or more magnets of the one or more permanent magnets 108 may be positioned at a selectively chosen distance relative to a top wall 126, a bottom wall 130, or a side wall 128 of the fluid container 102. In one aspect, one or more magnets of the one or more permanent magnets 108 may be positioned away from the fluid container 102 at a distance from about 1 centimeter to about 1 meter, including all increments of 1 centimeter therebetween. For instance, in one aspect, one or more magnets of the one or more permanent magnets 108 may be positioned away from a top wall 126, a bottom wall 130, or a side wall 128 of the fluid container 102 at a distance of about 1 centimeter or more, such as about 0.1 meters or more, such as about 0.2 meters or more, such as about 0.4 meters or more, such as about 0.6 meters or more, such as about 0.8 meters or more, such as about 1 meter or less, such as about 0.8 meters or less, such as about 0.6 meter or less, such as about 0.4 meters or less, such as about 0.2 meter or less, such as about 0.8 meters or less, such as about 0.6 meters or less, such as about 0.4 meters or less, such as about 0.2 meters or less, such as about 0.1 meters or less.

As illustrated in FIG. 1, a magnet driving element 112 may be coupled by a mechanical coupling 116 to a magnet support member 110 and/or one or more permanent magnets 108 (e.g., a plurality of permanent magnets). In one aspect, a magnet driving element 112 may be coupled by a mechanical coupling 116 to another, different magnet driving element 112. In general, a magnet driving element 112 may be in the form of an actuator. For instance, a magnet driving element 112 may be a rotary actuator, a linear actuator, and/or any other practicable type of actuator. As further illustrated in FIG. 1, the system 100 may include more than one magnet driving element 112. For instance, in one aspect, the system 100 may include a linear actuator and a rotary actuator. In one aspect, when a magnet support member 110 and/or one or more magnets of the one or more permanent magnets 108 is coupled to one or more of the magnet driving elements 112, the one or more magnet driving elements 112 may move the magnet support member 110 and/or the magnet of the one or more permanent magnets 108 from a first position to a second position and then from the second position back to the first position in a continuous manner, such as with a linear actuator. In one aspect, the second position of a magnet support member 110 and/or one or more magnets of the one or more permanent magnets 108 may be closer to the fluid container 102 than the first position of a magnet support member 110 and/or one or more magnets of the one or more permanent magnets 108.

In one aspect, when a magnet support member 110 or one or more magnets of the one or more permanent magnets 108 is coupled to one or more of the magnet driving elements 112, a magnet driving element of the one or more magnet driving elements 112 may rotate the magnet support member 110 and/or one or more magnets of the one or more permanent magnets 108. Generally, a magnet driving element 112 may be configured to rotate a magnet support member 110 about a rotational axis 124. In one aspect, when one or more permanent magnets 108 (e.g., a plurality of permanent magnets) are affixed or supported by a magnet support member 110, the one or more permanent magnets 108 may be rotated relative to the fluid container 102 about the rotational axis 124. For instance, the one or more permanent magnets 108 may be rotated relative to a top wall 126, a bottom wall 130, or a side wall 128 of the fluid container 102 about the rotational axis 124. The rotational axis 124 of a magnet support member 110, in one aspect, is illustrated in FIG. 4. As illustrated in FIG. 1, in one aspect, the rotational axis 124 may be offset from the center axis 134 of a fluid container 102. In another aspect, the rotational axis 124 may be in-line with the center axis of a fluid container 102.

In general, a magnet driving element 112 may rotate the magnet support member 110 and/or one or more magnets of the one or more permanent magnets 108 at a selectively chosen rate. For instance, in one aspect, a magnet driving element 112 may rotate the magnet support member 110 and/or one or more magnets of the one or more permanent magnets 108 at a rate of about 1 rpm to about 5000 rpm, such as about 1 rpm or more, such as about 100 rpm or more, such as about 200 rpm or more, such as about 500 rpm or more, such as about 1000 rpm or more, such as about 2000 rpm or more, such as about 3000 rpm or more, such as about 4000 rpm or more, such as about 5000 rpm or less, such as about 4000 rpm or less, such as about 3000 rpm or less, such as about 2000 rpm or less, such as about 1000 rpm or less, such as about 500 rpm or less, such as about 200 rpm or less, such as about 100 rpm or less.

In general, the one or more permanent magnets 108 may generate a uniform magnetic field or a nonuniform magnetic field (e.g., rotating magnetic field). For instance, in one aspect, the rotation of a magnet support member 110 and/or one or more magnets of the one or more permanent magnets 108 may generate a rotating and/or alternating magnetic field that disperses a plurality of particles 106 throughout or across a portion of a fluid 104 in a fluid container 102. The magnetic field generated by the one or more permanent magnets 108 may disperse the plurality of particles 106 uniformly or homogeneously throughout the fluid 104 of the fluid container 102.

In one aspect, the rotation of a magnet support member 110 and/or one or more magnets of the one or more permanent magnets 108 by a magnet driving element 112 may be such that it results in at least one eddy current (e.g., two eddy currents, three eddy currents, etc.) being formed relative to the fluid container 102. In this respect, the rotation of a magnet support member 110 and/or one or more magnets of the one or more permanent magnets 108 by a magnet driving element 112 may be such that it results in at least one eddy current being formed relative to a top wall 126, a bottom wall 130, or a side wall 128 of the fluid container 102. In one aspect, the rotation of a magnet support member 110 and/or one or more magnets of the one or more permanent magnets 108 by a magnet driving element 112 may generate one or more eddy currents relative to the fluid container 102.

In one aspect, one or more eddy currents may result in an amount of turbulence being created within the fluid 104 of the fluid container 102 to facilitate dispersion of the plurality of particles 106 across at least a portion of the fluid 104 of the fluid container 102. In one aspect, an eddy current resulting from the rotation of a magnet support member 110 and/or one or more magnets of the one or more permanent magnets 108 by a magnet driving element 112 may create turbulence within the fluid 104 of the fluid container 102 such that the particles of the plurality of particles 106 are dispersed throughout or across at least a portion of the fluid container 102. For instance, an eddy current may disperse the plurality of particles 106 uniformly or homogeneously throughout the fluid 104 of the fluid container 102. In one aspect, an eddy current formed by the rotation of a magnet support member 110 and/or one or more permanent magnets 108 may generate heat within a metal material, such as the material that forms a top wall 126, a bottom wall 130, or a side wall 128 of the fluid container 102, that is transferred to the fluid 104 of the fluid container 102 to cause turbulence within the fluid container 102 that disperses the plurality of particles 106. In this respect, an eddy current may heat the fluid 104 of the fluid container 102 such that the fluid 104 is a heated fluid, which may result in the fluid 104 at least partially boiling. The boiling or partial boiling of the fluid 104 of the fluid container 102 may contribute to turbulence within the fluid container 102 or create turbulence within the fluid container 102.

In one aspect, as illustrated in FIG. 1, a separate component 136 from the fluid container 102 may optionally be positioned between the fluid container 102 and at least one magnet of the one or more permanent magnets 108. For instance, a separate component 136 from the fluid container 102 may be positioned between the fluid container 102 and a plurality of permanent magnets. The dotted outline of the separate component 136 is indicative of the separate component being ‘optional’. The separate component 136 may be formed from a metal material. For instance, the separate component 136 may comprise aluminum, chromium, cobalt, copper, dysprosium, gadolinium, iron, lead, magnesium, manganese, neodymium, nickel, platinum, titanium, zinc, or a combination or alloy thereof. In one aspect, an eddy current formed by rotation of the one or more permanent magnets 108 may generate heat within the metal material of the separate component 136 that is transferred to the fluid 104 of the fluid container 102 to cause turbulence within the fluid container 102 that disperses the plurality of particles 106. Such a configuration may be beneficial when the fluid container 102 does not comprise a suitable metal material that would result in an eddy current being formed by the rotation of a magnet support member 110 and/or one or more magnets of the one or more permanent magnets 108.

In one aspect, as illustrated in FIG. 1, a controller element 118 may be in electric communication with one or more magnet driving elements 112 and/or one or more permanent magnets 108. The controller element 118 may be coupled to one or more magnet driving elements 112 and/or one or more permanent magnets 108 by one or more electrical couplings 114. The controller element 118 may be configured to drive, control, or activate one or more magnet driving elements 112 and/or one or more permanent magnets 108. In one aspect, the controller element 118 may be configured to provide or transmit an electric signal to drive, control, or activate one or more magnet driving elements 112 and/or one or more permanent magnets 108. For instance, a controller element 118 may be configured to control at least one magnet driving element 112 such that the at least one magnet driving element 112 rotates a plurality of permanent magnets relative to the fluid container 102.

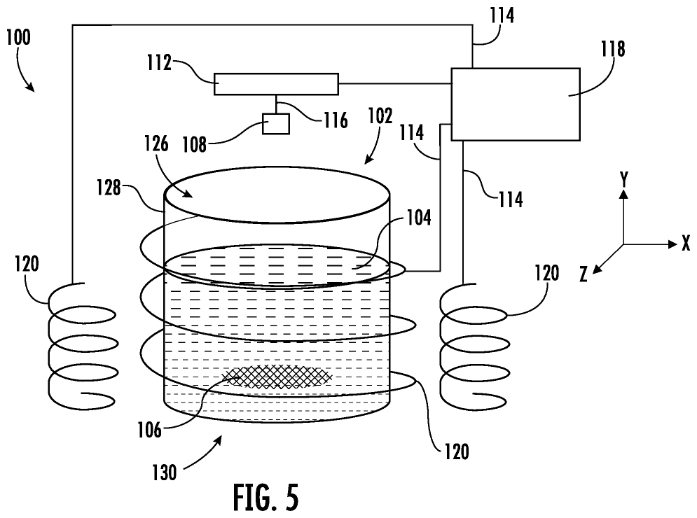

As illustrated in FIG. 5, in one aspect, an embodiment of the disclosed system 100 may comprise one or more electromagnetic coils 120 and one or more permanent magnets 108. The one or more electromagnetic coils 120 may include one or more solenoid electromagnetic coils, such as the electromagnetic coils illustrated in FIG. 5. In general, the solenoid electromagnetic coils may be short, long, regular, irregular, cylindrical, and/or non-cylindrical. In one aspect the one or more electromagnetic coils 120 may comprise silver, gold, copper, or more generally any conductor of electricity. In one aspect, the one or more electromagnetic coils 120 may comprise a magnetic core, such as a ferromagnetic core or a ferrimagnetic core. The core of an electromagnetic coil of the one or more electromagnetic coils 120 may be a closed-core or an open-core. In this respect, the one or more electromagnetic coils 120 may comprise one or more electromagnetic coils that are closed-core coils or open-core coils. In one aspect, the one or more electromagnetic coils 120 may comprise aluminum, copper, iron, nickel, or a combination or alloy thereof. In general, the one or more electromagnetic coils 120 may generate a uniform electromagnetic field or a nonuniform electromagnetic field

In one aspect, as illustrated in FIG. 5, one or more electromagnetic coils 120 may be positioned parallel to the fluid container 102. Further, as illustrated in FIG. 5, an electromagnetic coil of the one or more electromagnetic coils 120 may encircle or surround the fluid container 102. Notably, in one aspect, one or more electromagnetic coils of the one or more electromagnetic coils 120 may wrap around the fluid container 102. In one aspect, one or more electromagnetic coils 120 may be positioned away from the fluid container 102 at a selectively chosen distance. For instance, one or more electromagnetic coils 120 may be positioned at a selectively chosen distance relative to a top wall 126, a bottom wall 130, or a side wall 128 of the fluid container 102. In one aspect, one or more electromagnetic coils 120 may be positioned away from the fluid container 102 at a distance from about 1 centimeter to about 1 meter, including all increments of 1 centimeter therebetween. For instance, one or more electromagnetic coils 120 may be positioned away from a top wall 126, a bottom wall 130, or a side wall 128 of the fluid container 102 at a distance of about 1 centimeter or more, such as about 0.1 meters or more, such as about 0.2 meters or more, such as about 0.4 meters or more, such as about 0.6 meters or more, such as about 0.8 meters or more, such as about 1 meter or less, such as about 0.8 meters or less, such as about 0.6 meter or less, such as about 0.4 meters or less, such as about 0.2 meter or less, such as about 0.1 meters or less.

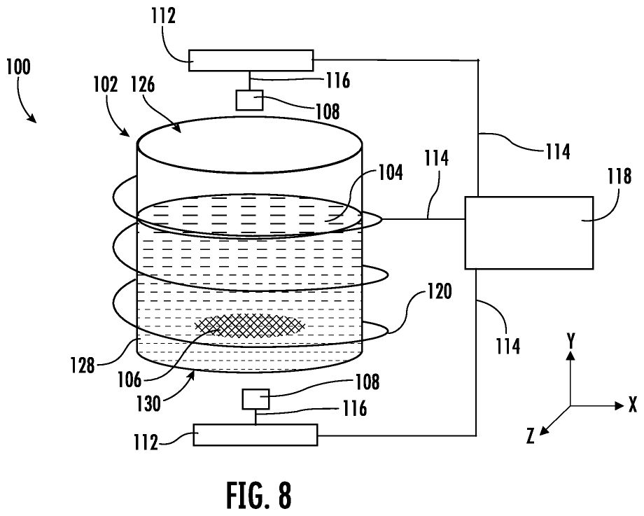

Referring still to FIG. 5, a magnet of the one or more permanent magnets 108 may be positioned relative to a top wall 126 of a fluid container 102. For instance, in one aspect a bar magnet may be placed relative to the top wall 126 of a fluid container 102. Additionally or alternatively, as illustrated in FIG. 8, a bar magnet may be placed relative to the bottom wall 130 of the fluid container 102.

In general, the one or more electromagnetic coils 120 and/or the one or more permanent magnets 108 may be utilized to aggregate or cluster a plurality of particles 106 in the fluid 104 of the fluid container 102 to form one or more particle clusters 106a. For instance, the one or more electromagnetic coils 120 and/or the one or more permanent magnets 108 may generate an electromagnetic field and/or magnetic field that aggregates or clusters a plurality of particles 106 into one or more particle clusters 106a. The one or more electromagnetic coils 120 and/or the one or more permanent magnets 108 may aggregate or cluster a plurality of particles 106 relative to a bottom wall 130 or a top wall 126 of a fluid container 102. In one aspect, the one or more electromagnetic coils 120 may produce an electromagnetic field, such as a rotating electromagnetic field that aggregates or clusters the plurality of particles 106. In another aspect, one or more magnet driving elements 112 may be coupled by mechanical couplings 116 to one or more permanent magnets 108. In this respect, the one or more permanent magnets 108 may be rotated or displaced by one or more magnet driving elements 112 (e.g., rotary actuator, linear actuator) to form a magnetic field that may aggregate or cluster a plurality of particles 106 in a fluid 104 of a fluid container 102.

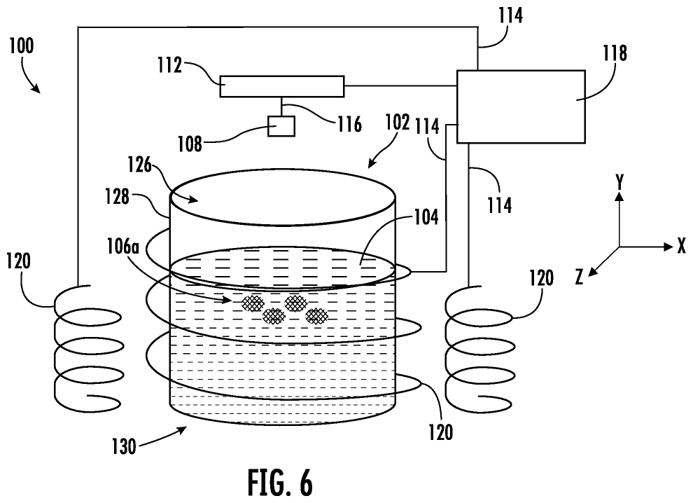

In general, the one or more electromagnetic coils 120 and/or the one or more permanent magnets 108 may propel, levitate, or raise a plurality of particles 106 in the fluid 104 of the fluid container 102. For instance, FIG. 6 illustrates one aspect of a raised plurality of particles 106. The one or more electromagnetic coils 120 and/or the one or more permanent magnets 108 may generate an electromagnetic field and/or magnetic field that propels, levitates, or raises a plurality of particles 106 (e.g., one or more particle clusters). In one aspect, the one or more electromagnetic coils 120 and/or the one or more permanent magnets 108 may propel, levitate, or raise a plurality of particles 106 after the one or more electromagnetic coils 120 and/or the one or more permanent magnets 108 aggregate or cluster the same plurality of particles 106 into one or more particle clusters 106a. The one or more electromagnetic coils 120 and/or the one or more permanent magnets 108 may propel, levitate, or raise a plurality of particles 106 relative to a top wall 126 of a fluid container 102. In one aspect, the one or more electromagnetic coils 120 may produce an electromagnetic field, such as a rotating electromagnetic field that propels, levitates, or raises the plurality of particles 106. In another aspect, one or more magnet driving elements 112 may be coupled by mechanical couplings 116 to one or more permanent magnets 108. In this respect, the one or more permanent magnets 108 may be rotated or displaced by one or more magnet driving elements 112 (e.g., rotary actuator, linear actuator) to form a magnetic field that may propel, levitate, or raise a plurality of particles 106 in a fluid 104 of a fluid container 102.

In general, the one or more electromagnetic coils 120 and/or the one or more permanent magnets 108 may break apart, disassemble, or disperse a plurality of particles 106 in the fluid 104 of the fluid container 102. For instance, the one or more electromagnetic coils 120 and/or the one or more permanent magnets 108 may generate an electromagnetic field and/or magnetic field that breaks apart, disassembles, or disperses a plurality of particles 106. In one aspect, the one or more electromagnetic coils 120 and/or the one or more permanent magnets 108 may break apart, disassemble, or disperse a plurality of particles 106 after the one or more electromagnetic coils 120 and/or the one or more permanent magnets 108 propel, levitate, or raise the same plurality of particles 106. The one or more electromagnetic coils 120 and/or the one or more permanent magnets 108 may break apart, disassemble, or disperse a plurality of particles 106 homogeneously or uniformly throughout a fluid 104. In one aspect, the one or more electromagnetic coils 120 may produce an electromagnetic field, such as a rotating electromagnetic field that breaks apart, disassembles, or disperses the plurality of particles 106. In another aspect, one or more magnet driving elements 112 may be coupled by mechanical couplings 116 to one or more permanent magnets 108. In this respect, the one or more permanent magnets 108 may be rotated or displaced by one or more magnet driving elements 112 (e.g., rotary actuator, linear actuator) to form a magnetic field that may break apart, disassemble, or disperse a plurality of particles 106 homogeneously or uniformly throughout a fluid 104. Notably, in one aspect, one or more electromagnetic coils of the one or more electromagnetic coils 120 that encircle or wrap around the fluid container 102 may break apart, disassemble, or disperse a plurality of particles 106 in the fluid 104.

As previously disclosed herein, the system 100 may disperse particles by aggregating or clustering a plurality of particles 106 into one or more particle clusters 106a, then propelling, levitating, or raising the one or more particle clusters 106a, followed by breaking apart, disassembling, or dispersing the previously propelled, levitated, or one or more raised particle clusters 106a. In one aspect, one or more electromagnetic fields and/or one or more magnetic fields may be generated relative to the fluid container 102 by the one or more electromagnetic coils 120 and/or the one or more permanent magnets 108 to carry out any or all of the aforementioned process steps disclosed herein. For instance, a first electromagnetic field and/or a first magnetic field may be generated relative to the fluid container 102 to aggregate or cluster a plurality of particles 106 into one or more particle clusters 106a. Next, a second electromagnetic field and/or a second magnetic field may be generated relative to the fluid container 102 to propel, levitate, or raise the one or more particle clusters 106a. Then, a third electromagnetic field and/or a third magnetic field may be generated relative to the fluid container 102 to break apart, disassemble, or disperse the one or more raised particle clusters 106a.

Generally, one or more of the one or more electromagnetic fields and/or one or more of the one or more magnetic fields may be generated sequentially. Additionally, or alternatively, one or more of the one or more electromagnetic fields and/or one or more of the one or more magnetic fields may be generated simultaneously. In one aspect, the duration of one or more electromagnetic fields and/or one or more of the one or more magnetic fields may overlap with the duration of one or more other, different electromagnetic fields and/or magnetic fields. For instance, a first electromagnetic field, a second electromagnetic field, and/or a third electromagnetic field may be active over a portion of the duration that another, different electromagnetic field is active. Further, for instance, a first magnetic field, a second magnetic field, and/or a third magnetic field may be active over a portion of the duration that another, different magnetic field is active. Additionally, for instance, a respective electromagnetic field may be active over a portion of the duration a respective magnetic field is active. Moreover, for instance, a respective magnetic field may be active over a portion of the duration a respective electromagnetic field is active.

As illustrated in FIG. 5, a controller element 118 may be in electric communication with one or more magnet driving elements 112, one or more permanent magnets 108, one or more electromagnetic coils 120, or a combination thereof. The controller element 118 may be coupled to one or more magnet driving elements 112, one or more permanent magnets 108, and/or one or more electromagnetic coils 120 by one or more electrical couplings 114. The controller element 118 may be configured to drive, control, or activate one or more magnet driving elements 112, one or more permanent magnets 108, and/or one or more electromagnetic coils 120. In this respect, the controller element 118 may be configured to provide or transmit an electric signal to drive, control, or activate one or more magnet driving elements 112, one or more permanent magnets 108, and/or one or more electromagnetic coils 120. In one aspect, when the controller element 118 activates one or more magnet driving elements 112, one or more permanent magnets 108, and/or one or more electromagnetic coils 120, the respective one or more magnet driving elements 112, one or more permanent magnets 108, and/or one or more electromagnetic coils 120 may generate a respective magnetic field and/or a respective electromagnetic field. In one aspect, the controller element 118 may include an arbitrary waveform generator.

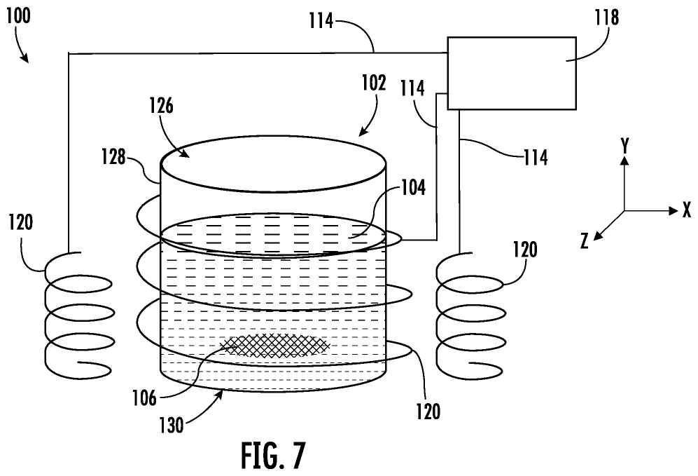

As illustrated in FIG. 7, another embodiment of a system 100 in accordance with the present disclosure may not comprise one or more permanent magnets 108. In one aspect, the one or more electromagnetic coils 120 may have one or more sets of electromagnetic coils. In one aspect, one or more electromagnetic coils 120 may disperse particles by aggregating or clustering a plurality of particles 106 into one or more particle clusters 106a, then propelling, levitating, or raising the one or more particle clusters 106a, followed by breaking apart, disassembling, or dispersing the previously propelled, levitated, or one or more raised particle clusters 106a. In one aspect, a first electromagnetic coil or a first set of electromagnetic coils may aggregate or cluster a plurality of particles 106 into one or more particle clusters 106a. In one aspect, a second electromagnetic coil or a second set of electromagnetic coils may propel, levitate, or raise one or more particle clusters 106a. In one aspect, a third electromagnetic coil or third set of electromagnetic coils may break apart, disassemble, or disperse the previously propelled, levitated, or one or more raised particle clusters 106a. Notably, in some aspects, a respective electromagnetic coil or respective set of electromagnetic coils may perform one or more, such as two or more, of the aforementioned process steps. For instance, in one aspect, a first electromagnetic coil or a first set of electromagnetic coils may aggregate or cluster a plurality of particles 106 into one or more particle clusters 106a, may propel, levitate, or raise the one or more particle clusters 106a; and/or may break apart, disassemble, or disperse the previously propelled, levitated, or one or more raised particle clusters 106a. In another aspect, a second electromagnetic coil or a second set of electromagnetic coils may aggregate or cluster a plurality of particles 106 into one or more particle clusters 106a, may propel, levitate, or raise the one or more particle clusters 106a; and/or may break apart, disassemble, or disperse the previously propelled, levitated, or one or more raised particle clusters 106a. In yet another aspect, a third electromagnetic coil or a third set of electromagnetic coils may aggregate or cluster a plurality of particles 106 into one or more particle clusters 106a, may propel, levitate, or raise the one or more particle clusters; and/or may break apart, disassemble, or disperse the previously propelled, levitated, or one or more raised particle clusters 106a.

As illustrated in FIG. 8, a further embodiment of a system 100 in accordance with the present disclosure may comprise at least two permanent magnets 108. The one or more permanent magnets 108 may have one or more sets of permanent magnets. In one aspect, a first permanent magnet or a first set of permanent magnets may aggregate or cluster a plurality of particles 106 into one or more particle clusters 106a. In one aspect, a second permanent magnet or second set of permanent magnets may propel, levitate, or raise one or more particle clusters 106a. In one aspect, a third permanent magnet or third set of permanent magnets may break apart, disassemble, or disperse the previously propelled, levitated, or raised particle clusters 106a. In another aspect, one or more electric coils of the one or more electromagnetic coils 120 may break apart, disassemble, or disperse the previously propelled, levitated, or raised particle clusters 106a. Notably, in some aspects, a respective permanent magnet or respective set of permanent magnets may perform one or more, such as two or more, of the aforementioned process steps. For instance, in one aspect, a first permanent magnet or a first set of permanent magnets may aggregate or cluster a plurality of particles 106 into one or more particle clusters 106a, may propel, levitate, or raise the one or more particle clusters 106a; and/or may break apart, disassemble, or disperse the previously propelled, levitated, or one or more raised particle clusters 106a. In another aspect, a second permanent magnet or a second set of permanent magnets may aggregate or cluster a plurality of particles 106 into one or more particle clusters 106a, may propel, levitate, or raise the one or more particle clusters 106a; and/or may break apart, disassemble, or disperse the previously propelled, levitated, or one or more raised particle clusters 106a. In yet another aspect, a third permanent magnet or a third set of permanent magnets may aggregate or cluster a plurality of particles 106 into one or more particle clusters 106a, may propel, levitate, or raise the one or more particle clusters 106a; and/or may break apart, disassemble, or disperse the previously propelled, levitated, or one or more raised particle clusters 106a.

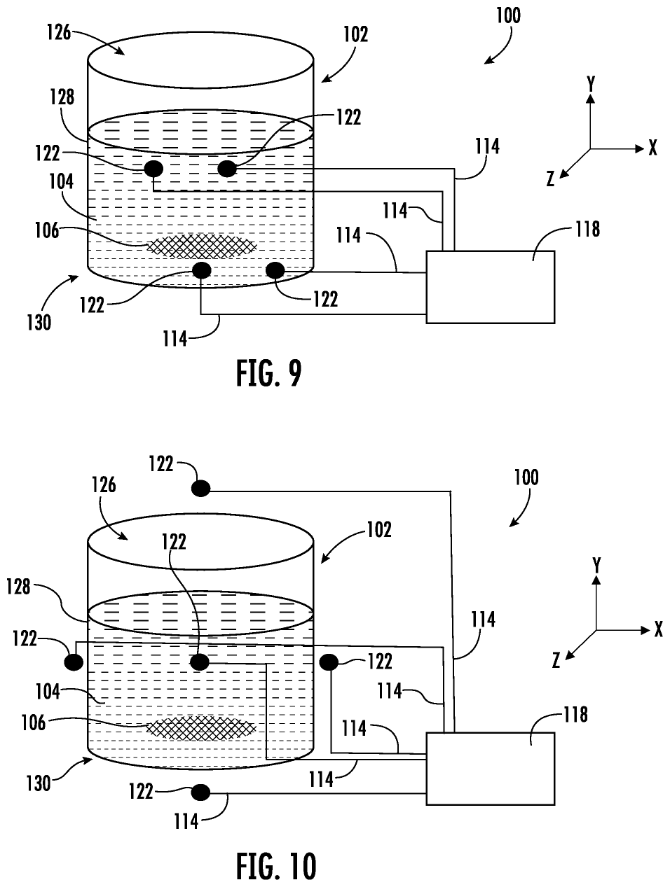

As illustrated in FIG. 9, in one aspect, yet another embodiment of the disclosed system 100 may comprise one or more electrodes 122. In one aspect, the one or more electrodes 122 may be positioned relative to the fluid container 102. In general, the system 100 may comprise one or more pairs of electrodes. For instance, the system 100 may comprise one or more pairs of electrodes or more, such as two or more pairs of electrodes or more, such as three or more pairs of electrodes or more, such as four or more pairs of electrodes or more, such as five or more pairs of electrodes or more, such as six or more pairs of electrodes or more. The one or more electrodes 122 may include an anode, a cathode, or a combination thereof. In one aspect, the one or more electrodes 122 may comprise brass, copper, carbon (e.g., graphite), lithium, gold, manganese, silver, platinum, titanium, zinc, or a combination or alloy thereof. In general, the one or more electrodes 122 may generate a uniform electric field or a nonuniform electric field.

As illustrated in FIG. 9, a controller element 118 may be in electric communication with one or more electrodes 122. The controller element 118 may be coupled to one or more electrodes 122 by one or more electrical couplings 114. In one aspect, the controller element 118 may be configured to provide or transmit an electric signal to activate the one or more electrodes 122. The controller element 118 may be configured to activate one or more electrodes 122 (e.g., two or more pairs of electrodes) such that one or more electric fields are generated to disperse the plurality of particles 106 in the fluid 104 of the fluid container 102. In this respect, two or more pairs of electrodes may be configured to generate an electric field upon activation of the respective pair of electrodes. In one aspect, the controller element 118 may include an arbitrary waveform generator.

Generally, one or more of the one or more electrodes 122 may be activated sequentially by the controller element 118. In this respect, one or more electric fields may be generated sequentially. Additionally, or alternatively, one or more of the one or more electrodes 122 may be activated simultaneously by the controller element 118. In this respect, one or more of the one or more electric fields may be generated simultaneously. In one aspect, the duration of one or more electric fields may overlap with the duration of one or more other, different electric fields.

In one aspect, the one or more electrodes 122 may be activated by the controller element 118 in a helical sequence to disperse the plurality of particles 106 in the fluid 104 of the fluid container 102. For instance, a lowermost pair of electrodes may be activated to begin the helical sequence. Next, a second pair of electrodes above the lowermost pair of electrodes may be activated to continue the helical sequence. Then, a third pair of electrodes above the second pair of electrodes may be activated to continue the helical sequence. In one aspect, the one or more electrodes 122 may be continuously, successively activated. In this respect, the activation sequence of one or more electrodes 122 may be repeated any number of times (e.g., two times, three times, four times) to disperse the plurality of particles 106 in the fluid 104 of the fluid container 102. In one aspect, the activation of the one or more electrodes 122 (e.g., two or more pairs of electrodes) in a helical sequence may result in a helical flow or vortex flow in at least a portion of the fluid 104 of the fluid container 102. In one aspect, a helicoidal flow or vortex flow resulting from the sequential activation of one or more electrodes 122 may disperse the plurality of particles 106 in the fluid 104 of the fluid container 102. Notably, any number of electrodes or pairs of electrodes may be utilized in a helical sequence as disclosed herein.

In general, the one or more electrodes 122 may generate a uniform electric field or a nonuniform electric field (e.g., rotating electric field). Notably, an electric field resulting from the one or more electrodes 122 may disperse the particles of the plurality of particles 106 throughout or across at least a portion of the fluid container 102. For instance, an electric field formed by the one or more electrodes 122 may disperse the plurality of particles 106 uniformly or homogeneously throughout or across the fluid 104 of the fluid container 102.

In one aspect, as illustrated in FIG. 10, one or more electrodes 122 or one or more pairs of electrodes may be affixed to a top wall 126, a side wall 128, a bottom wall 130, or a combination thereof of the fluid container 102. For instance, in one aspect, the system 100 may comprise at least six electrodes. In one aspect, at least one or electrode of the one or more electrodes 122 may be positioned relative to a top wall 126 of the fluid container 102. In one aspect, at least one electrode of the one or more electrodes 122 may be positioned relative to a bottom wall 130 of the fluid container 102. In one aspect, at least four electrodes of the one or more electrodes 122 may be positioned relative to a side wall 128 of the fluid container 102. In one aspect, the one or more locations of the electrodes of the one or more electrodes 122 may be positioned on opposed sides of the fluid container 102. For instance, a first location of one or more electrodes of the one or more electrodes 122 and a second location of one or more electrodes of the one or more electrodes 122 may be positioned on opposed sides of the fluid container 102. Notably, one or more electrodes 122 may be positioned on a side wall 128 of the fluid container not illustrated in FIG. 10. FIG. 11, for instance, illustrates two pairs of electrodes, each electrode of the respective pair of electrodes being positioned on opposed sides of the fluid container 102. In one aspect, electrode 122a and electrode 122c are a pair of electrodes positioned on opposed sides of the fluid container 102 and electrode 122b and electrode 122d are another, different pair of electrodes positioned on opposed sides of the fluid container 102.

Generally, the one or more electrodes 122 or one or more pairs of electrodes may be positioned relative to a top wall 126, a side wall 128, a bottom wall 130, or a combination thereof of the fluid container 102. In this respect, the one or more electrodes 122 may be positioned at a selectively chosen distance away from the fluid container 102. For instance, the one or more electrodes 122 may be positioned away from the fluid container 102 at a distance from about 1 centimeter to about 1 meter, including all increments of 1 centimeter therebetween. For instance, one or more electrodes of the one or more electrodes 122 may be positioned away from a top wall 126, a bottom wall 130, or a side wall 128 of the fluid container 102 at a distance of about 1 centimeter or more, such as about 0.1 meters or more, such as about 0.2 meters or more, such as about 0.4 meters or more, such as about 0.6 meters or more, such as about 0.8 meters or more, such as about 1 meter or less, such as about 0.8 meters or less, such as about 0.6 meter or less, such as about 0.4 meters or less, such as about 0.2 meter or less, such as about 0.1 meters or less.

Generally, the one or more electrodes 122 may be spaced at a selectively chosen position relative to the height of the fluid container 102. For instance, the one or more electrodes 122 may be positioned at about 1% or more of the height of the fluid container 102 as measured from the bottom wall 130 of the fluid container 102 to the top wall 126 of the fluid container, such as about 1% or more, such as about 5% or more, such as about 10% or more, such as about 20% or more, such as about 30% or more, such as about 40% or more, such as about 50% or more, such as about 60% or more, such as about 70% or more, such as about 80% or more, such as about 90% or more, such as about 100% or less, such as about 90% or less, such as about 80% or less, such as about 70% or less, such as about 60% or less, such as about 50% or less, such as about 40% or less, such as about 30% or less, such as about 20% or less, such as about 10% or less. For instance, in one aspect, an electrode of the one or more electrodes 122 that is positioned at 50% of the height of the fluid container 102 is equidistant from the bottom wall 130 of the fluid container and the top wall 126 of the fluid container. Further, in one aspect, an electrode of the one or more electrodes 122 that is positioned at 90% of the height of the fluid container 102 would have a position of 0.9 meters from the bottom wall 130 of a fluid container 102 for a fluid container 102 that has a height (i.e., length) of 1 meter.

In one aspect, the one or more electrodes 122 may comprise one or more electrodes positioned at different electrode locations, such as two electrode locations or more. For instance, the one or more electrodes 122 may comprise respective electrodes positioned at a first location and a second electrode positioned at a second location. For instance, two or more pairs of electrodes may comprise a first electrode positioned at a first location around an outer perimeter of the fluid container 102 defined by at least one side wall 128 and a second electrode positioned at a second location around the outer perimeter of the fluid container 102. As previously disclosed, the one or more locations of the electrodes of the one or more electrodes 122 may be on opposed sides of the fluid container 102. For instance, the first location and the second location may be on opposed sides of the fluid container 102.

In general, the one or more electrodes 122 may be positioned at one or more electrode position angles. The electrode position angle at which an electrode of the one or more electrodes 122 is positioned is determined from the perspective of an observer viewing the fluid container 102 from above, as illustrated in FIG. 11. Such a view may be referred to as a plan view. With respect to the electrode position angle, the electrode position angle is determined on the x-z plane, with “x” and “z” being horizontal directions that are perpendicular to one another, as illustrated in FIG. 11. Further, one arm of the electrode position angle extends in the right, horizontal direction and the other arm of the angle extends in the direction of the respective electrode of the one or more electrodes 122. The vertex of these two arms of the electrode position angle is formed in the center of the fluid container 102.

As previously disclosed, the one or more electrodes 122 may be positioned at one or more electrode position angles. For instance, as illustrated in FIG. 11, an electrode 122a of the one or more electrodes 122 may be positioned at a 90° electrode position angle. Further, for instance, as illustrated in FIG. 2, an electrode 122b of the one or more electrodes 122 may be positioned at a 180° electrode position angle. Furthermore, for instance, as illustrated in FIG. 2, an electrode 122c of the one or more electrodes 122 may be positioned at a 270° electrode position angle. It should be understood that the subscripts of the respective electrodes 122a, 122b, 122c, and 122d are utilized for illustrative purposes only and are not necessarily indicative of differences between the respective electrodes.

In general, an electrode of the one or more electrodes 122 may be affixed or positioned at an electrode position angle of 0° or more, such as 20° or more, such as 40° or more, such as 80° or more, such as 120° or more, such as 160° or more, such as 200° or more, such as 240° or more, such as 280° or more, such as 320° or more, such as 359° or less, such as 320° or less, such as 280° or less, such as 240° or less, such as 200° or less, such as 160° or less, such as 120° or less, such as 80° or less, such as 40° or less, such as 20° or less, including all increments of 1° therebetween.

In general, the one or more electrodes 122 may be utilized to aggregate or cluster a plurality of particles 106 in the fluid 104 of the fluid container 102 to form one or more particle clusters. For instance, the one or more electrodes 122 may generate an electric field that aggregates or clusters a plurality of particles 106 into one or more particle clusters. The one or more electrodes 122 may aggregate or cluster a plurality of particles 106 relative to a bottom wall 130 or a top wall 126 of a fluid container 102. In one aspect, the one or more electrodes 122 may produce an electric field, such as a rotating electric field that aggregates or clusters the plurality of particles 106.

In general, the one or more electrodes 122 may propel, levitate, or raise a plurality of particles 106 in the fluid 104 of the fluid container 102. In one aspect, the one or more electrodes 122 may generate an electric field that propels, levitates, or raises a plurality of particles 106 (e.g., one or more particle clusters). In one aspect, the one or more electrodes 122 may propel, levitate, or raise a plurality of particles 106 after the one or more electrodes 122 aggregate or cluster the same plurality of particles 106 into one or more particle clusters. The one or more electrodes 122 may propel, levitate, or raise a plurality of particles 106 relative to a top wall 126 of a fluid container 102.

In general, the one or more electrodes 122 may break apart, disassemble, or disperse a plurality of particles 106 in the fluid 104 of the fluid container 102. For instance, the one or more electrodes 122 may generate an electric field that breaks apart, disassembles, or disperses a plurality of particles 106. In one aspect, the one or more electrodes 122 may break apart, disassemble, or disperse a plurality of particles 106 after the one or more electrodes 122 propel, levitate, or raise the same plurality of particles 106. The one or more electrodes 122 may break apart, disassemble, or disperse a plurality of particles 106 homogeneously or uniformly throughout a fluid 104. In one aspect, the one or more electrodes 122 may produce an electric field that breaks apart, disassembles, or disperses the plurality of particles 106.

As previously disclosed herein, the system 100 may disperse particles by aggregating or clustering a plurality of particles 106 into one or more particle clusters, then propelling, levitating, or raising the one or more particle clusters, followed by breaking apart, disassembling, or dispersing the previously propelled, levitated, or one or more raised particle clusters. In one aspect, one or more electric fields may be generated relative to the fluid container 102 by the one or more electrodes 122, such as one or more pairs of electrodes. For instance, a first electric field may be generated by one or more electrodes 122 relative to the fluid container 102 to aggregate or cluster a plurality of particles 106 into one or more particle clusters. Next, a second electric field may be generated by one or more electrodes 122 relative to the fluid container 102 to propel, levitate, or raise the one or more particle clusters. Then, a third electric field may be generated by one or more electrodes 122 relative to the fluid container 102 to break apart, disassemble, or disperse the one or more raised particle clusters.

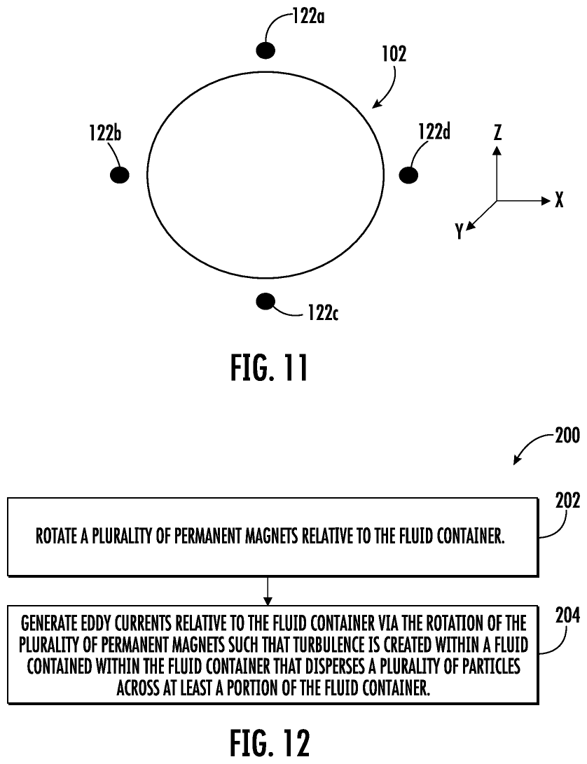

Referring now to FIG. 12, a flow diagram of one embodiment of a method 200 for dispersing particles in a fluid of a fluid container is illustrated in accordance with aspects of the present subject matter. As illustrated in FIG. 12, at 202, the method 200 may include rotating a plurality of permanent magnets relative to a fluid container. In some aspects, as illustrated in FIG. 12, at 204, the method 200 may include generating eddy currents relative to the fluid container via the rotation of the plurality of permanent magnets such that turbulence is created within a fluid contained within the fluid container that disperses a plurality of particles across at least a portion of the fluid container.

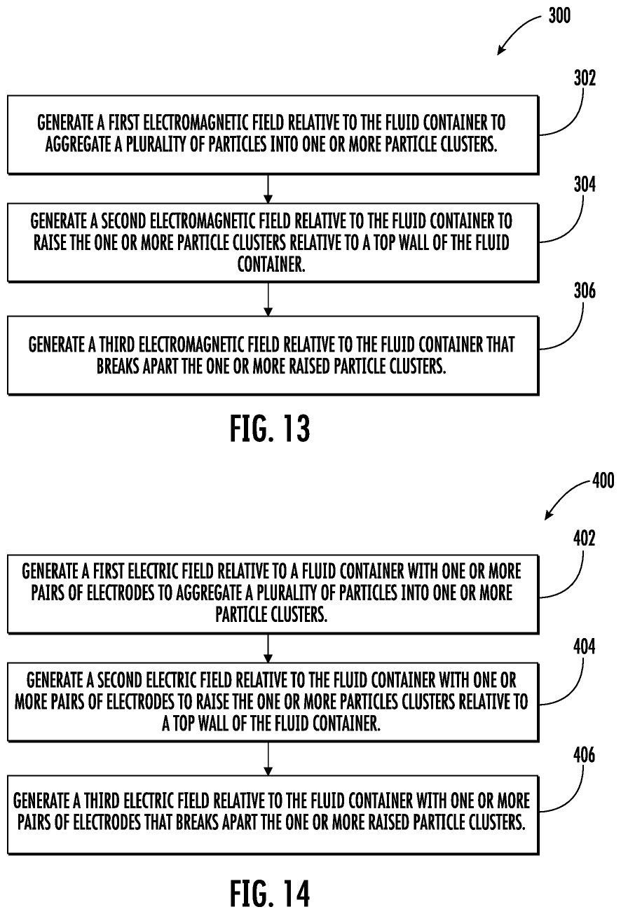

Referring now to FIG. 13, a flow diagram of one embodiment of a method 300 for dispersing particles in a fluid of a fluid container is illustrated in accordance with aspects of the present subject matter. As illustrated in FIG. 13, at 302, the method 300 may include generating a first electromagnetic field relative to the fluid container to aggregate a plurality of particles into one or more particle clusters. In some aspects, as illustrated in FIGS. 13, at 304 and 306, the method 300 may include generating a second electromagnetic field relative to the fluid container to raise the one or more particle clusters relative to a top wall of the fluid container and generating a third electromagnetic field relative to the fluid container that breaks apart the one or more raised particle clusters.

Referring now to FIG. 14, a flow diagram of one embodiment of a method 400 for dispersing particles in a fluid of a fluid container is illustrated in accordance with aspects of the present subject matter. As illustrated in FIG. 14, at 402, the method 400 may include generating a first electric field relative to a fluid container with one or more pairs of electrodes to aggregate a plurality of particles into one or more particle clusters. In some aspects, as illustrated in FIGS. 14, at 404 and 406, the method 400 may include generating a second electric field relative to the fluid container with one or more pairs of electrodes to raise the one or more particle clusters relative to a top wall of the fluid container and generating a third electric field relative to the fluid container with one or more pairs of electrodes that breaks apart the one or more raised particle clusters.

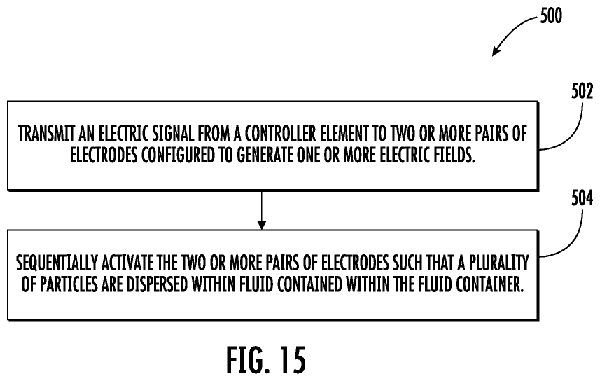

Referring now to FIG. 15, a flow diagram of one embodiment of a method 500 for dispersing particles in a fluid of a fluid container is illustrated in accordance with aspects of the present subject matter. As illustrated in FIG. 15, at 502, the method 500 may include transmitting an electric signal from a controller element to two or more pairs of electrodes configured to generate one or more electric fields. In some aspects, as illustrated in FIG. 15, at 504, the method 500 may include sequentially activating the two or more pairs of electrodes such that a plurality of particles are dispersed within fluid contained within the fluid container.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims or if they include equivalent structural elements with insubstantial differences from the literal language of the claims.

In the claims:

1. A system for dispersing particles, the system comprising:
a fluid container comprising a fluid and a plurality of particles; and
a controller element, the controller element configured to control one or more electric coils or one or more permanent magnets, the one or more electric coils or the one or more permanent magnets configured to sequentially generate a first electromagnetic field relative to the fluid container to aggregate the plurality of particles into one or more particle clusters, a second electromagnetic field relative to the fluid container to raise the one or more particle clusters relative to a top wall of the fluid container, and a third electromagnetic field relative to the fluid container that breaks apart the one or more raised particle clusters.

2. The system of claim 1, wherein the first electromagnetic field is generated by the one or more electric coils.

3. The system of claim 1, wherein the first electromagnetic field is generated by the one or more permanent magnets.

4. The system of claim 1, wherein the second electromagnetic field is generated by one or more electric coils.

5. The system of claim 1, wherein the second electromagnetic field is generated by one or more permanent magnets.

6. The system of claim 1, wherein the third electromagnetic field is generated by one or more electric coils.

7. The system of claim 1, wherein at least one electric coil of the one or more electric coils wrap around the fluid container.

8. A system for dispersing particles, the system comprising:
a fluid container containing a fluid and a plurality of particles;
two or more pairs of electrodes positioned relative to the fluid container, each of the two or more pairs of electrodes being configured to generate an electric field upon activation of the respective pair of electrodes; and
a controller configured to sequentially activate the two or more pairs of electrodes such that the plurality of particles are dispersed across at least a portion of the fluid container.

9. The system of claim 8, wherein each pair of electrodes comprises an anode and a cathode spaced apart from each other relative to the fluid container.

10. The system of claim 8, wherein each pair of electrodes comprises first and second electrodes positioned in parallel relative to the fluid container.

11. The system of claim 8, wherein the two or more pairs of electrodes comprises a first electrode positioned relative to a top wall of the fluid container and a second electrode positioned relative to a bottom wall of the fluid container.

12. The system of claim 8, wherein the fluid container comprises a top wall, a bottom wall, and at least one side wall extending between the top wall and the bottom wall, comprising a first electrode positioned at a first location around an outer perimeter of the fluid container defined by the at least one side wall and a second electrode positioned at a second location around the outer perimeter of the fluid container.

13. The system of claim 12, wherein the first and second locations are on opposed sides of the fluid container.

14. The system of claim 8, wherein the two or more pairs of electrodes comprise first, second, and third pairs of electrodes, wherein the first pair of electrodes comprises a first electrode positioned relative to a top wall of the fluid container and a second electrode positioned relative to a bottom wall of the fluid container, and wherein the second and third pairs of electrodes are spaced apart around an outer perimeter of the fluid container defined by at least one side wall of the fluid container extending between the top wall and the bottom wall.

15. A system for dispersing particles, the system comprising:
a fluid container containing a fluid and a plurality of particles;
a plurality of permanent magnets positioned relative to the fluid container;
at least one magnet driving element coupled to the plurality of permanent magnets and being configured to rotate the plurality of permanent magnets relative to the fluid container; and
a controller element configured to control at least one magnet driving element such that the at least one magnet driving element rotates the plurality of permanent magnets relative to the fluid container in a manner that causes eddy currents to be formed relative to the fluid container, the eddy currents resulting in turbulence being created within the fluid to facilitate dispersion of the plurality of particles across at least a portion of the fluid container.

16. The system of claim 15, wherein the plurality of permanent magnets are supported relative to the fluid container by a magnet support member, the at least one magnet driving element being configured to rotate the magnet support member about a rotational axis such that the plurality of permanent magnets are rotated relative to the fluid container about the rotational axis.

17. The system of claim 16, wherein the plurality of permanent magnets includes a set of first permanent magnets of a first polarity and a set of second permanent magnets of a second polarity, the sets of first and second permanent magnets being positioned in an alternating arrangement across the magnet support member.

18. The system of claim 16, wherein the rotational axis is offset from a center axis of the fluid container.

19. The system of claim 15, wherein at least a portion of the fluid container is formed from a metal material or a separate component formed from a metal material is positioned between the fluid container and the plurality of permanent magnets, wherein the eddy currents formed by rotation of the plurality of permanent magnets generate heat within the metal material that is transferred to the fluid to cause the turbulence within the fluid container that disperses the plurality of particles.

20. The system of claim 15, wherein rotation of the plurality of permanent magnets creates alternating magnetic fields relative to the fluid container to generate the eddy currents.
